(19) United States
(12) Patent Application Publication
(10) Pub. No.: US 2007/0245567 A1
(43) Pub. Date: Oct. 25, 2007

(54) Spatula with steam scraping mechanism

(76) Inventor: Jeremy S. Laufer, Menlo Park, CA (US)

Correspondence Address: LEVINE BAGADE HAN LLP, 2483 EAST BAYSHORE ROAD, SUITE 100, PALO ALTO, CA, 94303, US

(21) Appl. No.: 11/408,527

(22) Filed: Apr. 21, 2006

(51) Int. Cl. B25F 3/00

(52) U.S. Cl. 30/123.3

(57) ABSTRACT

Improved cooking utensils.

### BACKGROUND OF THE INVENTION

1. Field of the Inventions

The invention relates to cooking utensils such as spatulas, spoons, knives or other cooking implements.

2. Description of the Related Art

When cooking foods that have a tendency to adhere to a heated surface, it is sometimes difficult to place a cooking instrument (e.g., a spatula) underneath the food. For example, while eggs in a skillet, once the eggs solidify it is difficult to place a spatula underneath the cooking eggs without tearing the egg or yolk. However, wetting the spatula with water or other liquid allows the heat of the skillet to boil the water of the spatula and separates the skillet from the food being cooked. However, this requires a source of water such as a dipping pan or sink, and the amount of water present is sometimes so much that it causes splattering or steam burns on the cook. It is therefore desirable to have a mechanism on a spatula that delivers a metered amount of water to the proper part of the spatula when desired from a source contained to the spatula in order to separate food from a cooking pan more easily.

### BRIEF DESCRIPTION OF DRAWINGS

FIG. 1 shows a typical spatula of the current state of the art.

FIGS. 2A to 2C show variations of the channels according to the present devices.

FIG. 2 shows a spatula of the design of the current invention, showing the channels for water delivery.

FIG. 3 shows an alternative embodiment with a fluid source in fluid continuity with the channels.

FIG. 4 is yet another embodiment showing a fluid source removably connected to the spatula.

### DETAILED DESCRIPTION

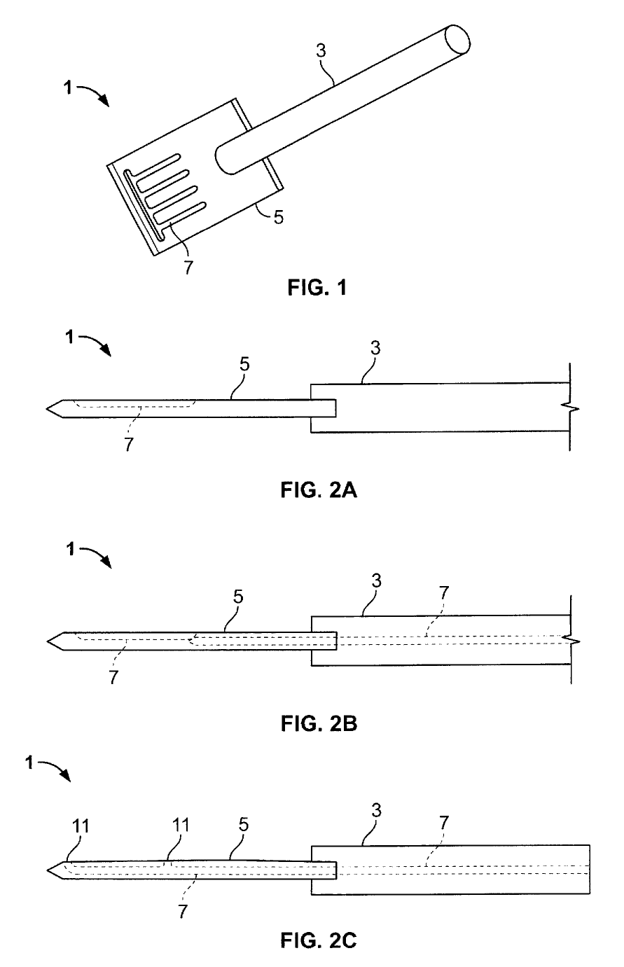

A spatula is generally a flat, thin tool that can be placed between cooking food and a hot cooking surface (such as pan, skillet, or grill). As shown in FIG. 1, a spatula 1 generally includes a handle portion 3, and a cooking portion 5 that typically comes in contact with both the food and cooking surface. In one variation of the invention, a spatula 1 includes narrow channels 7 that retain water by capillary attraction until the spatula is in contact with the hot skillet. Typically, water or other liquid is loaded by the cook. The heat draws the water out of the spatula 1. Upon exiting the channel, the heat causes the water to turn to steam, causing delivery of steam to the edge of the spatula's cooking portion 5 that is scraping between the food and cooking surface.

As shown in FIG. 1, one variation of the invention includes filling the channels by dipping the spatula 1 in water or placing the spatula 1 under running water. The channels may contain enough water from one or more scrapings before requiring recharging. In another embodiment, a fluid source 9 such as a fluid vessel or sponge is placed in fluid continuity with the channels of the spatula to allow more water delivery prior to requiring recharge.

FIG. 2A shows a side view of a cooking portion 5 and handle 3 of a spatula 1. As shown, the channels 7 may extend in a surface of the cooking portion 5. FIG. 2B shows another variation of a spatula 1, as described herein. In this variation, the channel 7 is coupled to a fluid source (as described below) where the channel 7 extend partially in a surface of the cooking portion 5 and ultimately extends within the cooking portion 5 and handle portion 3 to the fluid source. FIG. 2C illustrates a channel 7 extending within the cooking portion 5 and terminating at one or more ports 11 on a surface of the cooking portion 5.

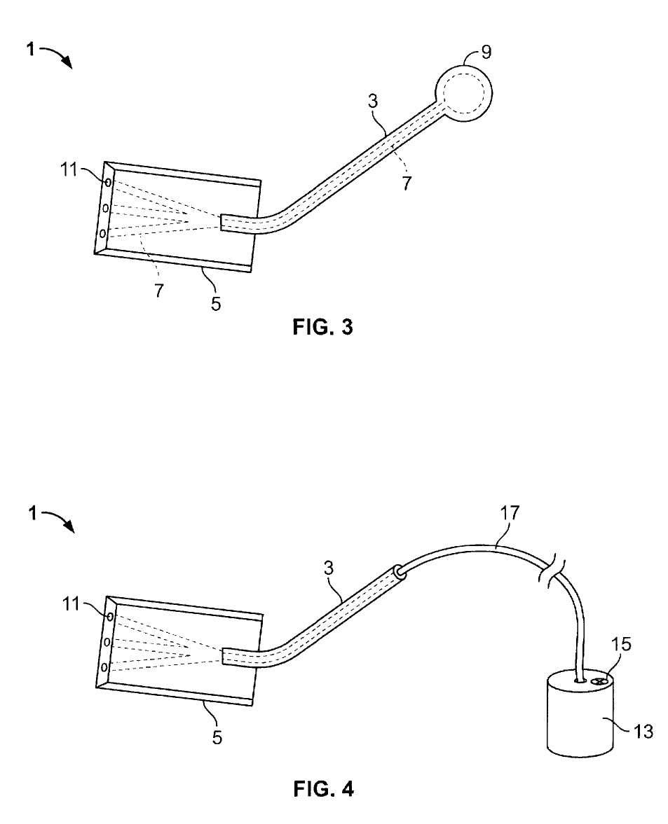

FIG. 3 shows a variation of a spatula 1 having a plurality of fluid channels 7 (the fluid channels may be exposed or hidden within the body of the spatula). If the fluid channels 7 are internal to the spatula 1, the channels 7 will terminate in fluid ports 11 (alternatively, all or a portion of the channels may be exposed in the cooking surface 5 as shown above). The fluid channels 7 are also shown to be coupled to the water source 9. The water source may be a sponge, bulb-type reservoir such as those found on basters. In either case, the water source may be actuated (e.g., compressed) to meter a quantity of fluid.

Alternatively, or in combination, as shown in FIG. 4, the fluid source may be an external fluid source 13. The external fluid source may have a pressurizing means 15 such as a pump-mechanism to assist in flowing of the fluid to the appropriate area. Also, the spatula 1 may be coupled (removably or fixed) to the water source 13 via a tube or other connector.

Once the spatula 1 is charged with water, spatula is then placed next to the food to be scraped in contact with the cooking surface. Steam is generated and the food is more easily separated from the cooking surface. The amount of steam created is determined by the size of the channels 7 and/or ports 11, which are designed to limit the amount of steam generated so as not to burn the cook.

Although the current disclosure discusses spatulas, it is specifically noted that the invention includes any other type of kitchen or cooking tool/implement that benefits from the generation of steam between a heated surface and food.

Devices described herein may be combined with water or other fluids (including gas or liquid). For example, the fluid may be sauce or other juices desired to add flavor to the food being cooked.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

Although the present inventions have been described in terms of the preferred embodiments above, numerous modifications and/or additions to the above-described preferred embodiments would be readily apparent to one skilled in the art. It is intended that the scope of the present inventions extend to all such modifications and/or additions and that the scope of the present inventions is limited solely by the claims of the invention.

We claim:

1. A tool for separating cooking food from a cooking surface that delivers a metered amount of water between the cooking food and the cooking surface that when converted to steam helps to separate the food from the cooking surface.

2. A tool as in claim 1 where the water is delivered by channels in the tool.

3. A tool as in claim 2 where the water is delivered to the channels from a vessel in fluid continuity with the channels.

4. A tool as in claim 3 where the vessel is a hollow vessel.

5. A tool as in claim 3 where the vessel is a sponge.

6. A method of separating food from a cooking surface consisting of delivering water through channels in a tool to the junction between the cooking surface and food.

7. A kitchen implement for delivering a fluid while cooking food on a heated surface, the implement comprising:
a handle portion;
a cooking portion having an exterior surface adapted to manipulate food on the heated surface; and
at least one fluid channel in the exterior surface, where the fluid channel is adapted to deliver water to the food.

8. The kitchen implement of claim 7, where the cooking portion comprises a planar surface.

9. The kitchen implement of claim 7, where the fluid channel is located within the cooking portion and terminates at a fluid delivery port on the exterior surface of the cooking portion.

10. The kitchen implement of claim 7, where the fluid channel is located on the surface of the cooking portion.

11. The kitchen implement of claim 7, further comprising a water reservoir coupled to the fluid channels.

12. The kitchen implement of claim 11, where the water reservoir comprises a sponge.

13. The kitchen implement of claim 11, where the water reservoir comprises a bulb-type reservoir.

14. The kitchen implement of claim 11, where the water reservoir comprises removable tube.

15. The kitchen implement of claim 11, where the water reservoir comprises a chamber having with a line adapted for removably coupling the chamber to the fluid channels.

16. The kitchen implement of claim 15, where the chamber has a pressurizing means.
